(19) United States
(12) Patent Application Publication
(10) Pub. No.: US 2024/0105348 A1
(43) Pub. Date: Mar. 28, 2024

(54) AMMONIA BORANE-FILLED BORON NITRIDE NANOTUBE FUSION TARGETS

(71) Applicant: BNNT, LLC, Newport News, VA (US)

(72) Inventors: R. Roy WHITNEY, Newport News, VA (US); Lyndsey R. SCAMMELL, Newport News, VA (US)

(21) Appl. No.: 18/262,655

(22) PCT Filed: Jan. 25, 2022
(86) PCT No.: PCT/US2022/013616

§ 371 Date: Jul. 24, 2023

Related U.S. Application Data
(60) Provisional application No. 63/141,427, filed on Jan. 25, 2021.

(51) Int. Cl. G21B 1/19

(52) U.S. Cl. CPC G21B 1/19

(57) ABSTRACT

This disclosure relates to the use of hydrogen storage compounds in boron nitride nanotube (BNNT) fusion targets. Such targets may be used with high power pulsed laser beams to produce proton nB fusion reactions. BNNT fusion targets having a hydrogen storage compound (such as ammonia borane) coating, and methods for making the same, are disclosed.

### STATEMENT REGARDING GOVERNMENT SUPPORT

None.

### FIELD OF THE INVENTION

The present disclosure relates to incorporating hydrogen storage compounds into boron nitride nanotubes (BNNTs), and more particularly, into BNNT fusion targets.

### BACKGROUND—INTRODUCTION

Fusion research has been active for over fifty years, and functioning, effective commercial reactors have yet to be achieved. Confining charged particles, numerous instabilities, and the large amount of energy required to sustain a fusion reaction continue to be challenges. There have been numerous configurations proposed to confine charged particles accelerated by electromagnetic means.

Laser technology has developed to the point where sustaining fusion reactions is achievable. The fusion reaction of interest involves the hydrogen nuclei with boron isotope 11, or ¹¹B. This reaction is known as the pB11 reaction. Each pB11 reaction produces three alpha particles, with an energy gain of 8.2 MeV. The energy gain can be converted into usable energy (e.g., electrical or heat energy). The pB11 reaction has numerous advantages, including abundant raw materials, a high energy yield, and less radioactivity per unit of energy produced when compared to coal burning.

The ignition of the pB11 reaction is considerably difficult. Some proposed methods involve lasers to create ¹¹B plasma, and separate lasers to accelerate a stream of protons into the plasma. The proton beam produces a tenfold increase of boron fusion, because protons and boron nuclei directly collide. Some methods require a magnetically confined plasma. The common aspect, though, is a fusion target providing sufficient ¹¹B to maximize the proton and boron nuclei interactions.

What is needed, then, is a fusion target providing the combination of sufficient ¹¹B and sufficient protons to maximize the proton and boron nuclei interactions. What is further needed is a boron fusion target having enhanced mass density and electron density, to increase the energy gain from the reaction.

### BRIEF SUMMARY

This disclosure relates to the use of one or more hydrogen storage compounds as an additive to fusion targets formed from low atomic number materials, such as those with lithium, beryllium, boron, carbon, nitrogen, fluorine, oxygen, and specifically to boron nitride nanomaterials such as boron nitride nanotubes (BNNT). The addition of a hydrogen storage compound to the low atomic number fusion target enhances the electron density and mass density of the fusion target. In turn, the fusion target provides for a more effective and efficient conversion of energy from laser beam and energetic electrons to photons when the materials are being irradiated as targets by intense pulsed laser beams, ideal for proton plus ¹¹B (pB11) fusion reactions.

A variety of hydrogen storage compounds are available for use as proton sources, and may be used without departing from the present approach. In this disclosure, ammonia borane, abbreviated as AB, and having the chemical formula (H₃NBH₃), is used as an example of a hydrogen storage compound and proton source. AB has been included in multiple boron nitride based (BN) materials, including, for example, BNNTs, in part because AB is considered to a good candidate for hydrogen storage. Other example compounds for H storage include methane, ammonia, alane (Al₃H₉), boron hydrides (such as diborane, B₂H₆), metal hydrides (such as MgH₂, NaAlH₄, LiAlH₄, LiH, LaNi₅H₆, TiFeH₂, palladium hydride, organoboranes, and hydrocarbons.

When intense pulsed laser beams of short pulse durations interact with materials, there are typically a series of compression waves of increased mass density and increased electron density that propagate into and possibly through the material. Under the influence of the intense laser pulse, the wave of compressed electrons can separate from the wave of compressed and more massive ions that have lost their electrons to the wave of electrons, and thereby create a wakefield type of acceleration electromagnetic field that will accelerate lighter ions such as protons and electrons. The strength and range of the wakefield acceleration depends on multiple parameters including the electron density and the intensity of the photon field generated by a combination of the laser and of photons generated by electron interactions with the ions and other electrons.

The addition of a hydrogen storage compound, such as AB, to a BNNT fusion target, results in a distribution of hydrogen and ¹¹B atoms within the fusion target for optimization of the pB11 fusion reactions.

The present approach may, in some embodiments, take the form of an ¹¹B fusion target made of BNNT material, and at least one hydrogen storage compound including ammonia borane. The hydrogen storage compound may, in some embodiments, include a further compound selected methane, ammonia, alane (Al₃H₉), a boron hydride, diborane (B₂H₆), a metal hydride, MgH₂, NaAlH₄, LiAlH₄, LiH, LaNi₅H₆, TiFeH₂, palladium hydride, an organoborane, and a hydrocarbon. In some embodiments, the hydrogen storage compound consists of ammonia borane. The hydrogen storage compound may be a coating on external surfaces of the BNNT material. In some embodiments, the hydrogen storage compound further coats interior surfaces of the BNNT material. The at least one hydrogen storage compound may be dispersed throughout the BNNT material. In some embodiments, the BNNT material is one of a BNNT mat, a BNNT buckypaper, a BNNT powder, and a BNNT puffball. In a demonstrative embodiment, an ¹¹B fusion target is made of a BNNT material with a coating of ammonia borane, the target for use with intense pulsed laser beams for achieving proton ¹¹B fusion. In some preferred embodiments, the BNNT material comprises a one of a BNNT mat and a BNNT buckypaper.

Some embodiments of the present approach take the form of a method for forming an ¹¹B fusion target. A hydrogen storage compound comprising ammonia borane may be dispersed into a BNNT material in a reaction vessel. In some embodiments, the reaction vessel may be under vacuum. In some embodiments, the hydrogen storage compound is heated to a temperature sufficient to evaporate the hydrogen storage compound and form an evaporated hydrogen storage compound in the reaction vessel. Next, the reaction vessel is cooled to a temperature sufficient to sublimate the evaporated hydrogen storage compound onto surfaces of the BNNT material.

In some embodiments, the hydrogen storage compound and the BNNT material are in solution. The components may be in the same solvent, or compatible solvents. The hydrogen storage compound is dispersed in the BNNT material through mixing the solution. In some embodiments, the solution may be heated to dissolve the at least one solvent. The solvent(s) may be removed from the solution of hydrogen storage compound dispersed in the BNNT material, forming a hydrogen storage compound-coated BNNT material. In some embodiments, the BNNT material has nanotubes with open ends. In such embodiments, the hydrogen storage compound may coat the exterior surfaces and the interior surfaces of the nanotubes in the BNNT material.

### DESCRIPTION OF THE DRAWINGS

FIG. 1 illustrates the relative sizes of BNNTs and AB molecules.

FIG. 2 shows a TEM image of BNNTs with AB present mostly on the inside of the BNNTs.

FIG. 3 shows a TEM image of BNNTs with AB present on the inside and outside of the BNNTs.

FIG. 4 illustrates a gas-phase process for adding a hydrogen storage compound to a BNNT material, according to one embodiment of the present approach.

FIG. 5 illustrates a solution-phase process for adding a hydrogen storage compound to a BNNT material, according to one embodiment of the present approach.

FIG. 6 shows a TEM image of BNNTs, without any hydrogen storage compound, with a 50 nm scale for comparison.

FIG. 7 shows a TEM image of BNNTs, without any hydrogen storage compound, with a 10 nm scale, for comparison.

### DETAILED DESCRIPTION

Described herein are various embodiments of boron nitride nanotube (BNNT) targets for fusion reactions, and methods for making the same. Under the present approach, BNNTs may be filled with a hydrogen storage compound, such as ammonium borane (AB), and used as a target for fusion reaction s between the protons in the AB and the ¹¹B atoms in the BNNTs and AB. Both the BNNT and the AB can be made with ¹¹B rather than natural boron to optimize the presence of ¹¹B in the target. The following description illustrates embodiments of the present approach in sufficient detail to enable practice of the present approach. Although the present approach is described with reference to these specific embodiments, it should be appreciated that the present approach can be embodied in different forms, and this description should not be construed as limiting any appended claims to the specific embodiments set forth herein. Rather, these embodiments are provided so that this disclosure will be thorough and complete, and will fully convey the scope of the present approach to those skilled in the art.

It should be appreciated that a variety of BNNT materials are presently available, and that the quality of BNNTs depends on the synthesis and refinement processes used to produce the BNNTs. BNNT can be synthesized with a variety of methods to include high temperature, high-pressure (HTP) methods, CVD methods and ball milling methods. The present approach may be practiced with most BNNT materials currently available, although the relative performance of the fusion target will depend on the quality of BNNT material used. HTP methods can produce high quality BNNTs, i.e., a few-wall (e.g. 1-10 walls, and mostly 2-3 walls) with a minimal amount of boron particulates, amorphous boron nitride (a-BN), BN nanocages, BN nanosheets, and any other non-BNNT materials. As used herein, the term “high quality” BNNT materials generally means that the BNNTs have: 1) high crystallinity, i.e., less than one crystal defect per one hundred diameters of length; 2) few walls, i.e., 70% of the BNNTs have 3 or fewer walls; 3) small diameters, i.e., 70% of the BNNTs have diameters below 8 nm; 4) about 80%, +/−5%, of the BNNTs have length:diameter aspect ratios greater than 100:1; and 5) 70%, +/−5%, of the BNNTs have lengths greater than 2 microns. CVD and ball milling methods typically produce BNNTs with 10-50 walls and more crystal defects than one per one hundred diameters of length. As a result, BNNTs produced through CVD or ball milling are not the most suitable options for the present approach, but nonetheless may be used. For pB11 fusion targets, having the boron particles present may benefit fusion reactions in some embodiments. For some pB11 fusion processes and embodiments having the boron particles, a-BN, BN nanocages and BN nanosheets removed through purification processes may be preferred, because this typically increases the surface area for the hydrogen storage compound (e.g., AB) to cover. The purification processes typically also open the ends of the BNNT tubes that might otherwise be covered with a-BN, BN nanocages and/or BN nanosheets, thereby allowing the additives to advantageously enter into and fill the interior of the nanotubes.

Under the present approach, “high quality BNNTs,” such as those produced by BNNT, LLC (Newport News, Virginia) are preferable for use as the BNNT material in most embodiments. Such BNNTs are produced by catalyst-free, high temperature, high pressure synthesis methods, have few defects, no catalyst impurities, 1- to 10-walls with a peak in wall distribution at 2-walls, and rapidly decreasing with larger number of walls. BNNT diameters typically range from 1.5 to 6 nm but may extend beyond this range, and lengths typically range from a few hundred (e.g., about 1 to about 5, and in some embodiments, about 2 to about 5, and in some embodiments, about 3 to about 5, wherein the term “about” in this context means+/−0.5) of nm to hundreds of microns, though depending on the synthesis process and conditions the lengths may extend beyond this range. For the as-produced BNNT material, high quality BNNTs typically make up about 50% of the bulk material, and boron particles, amorphous BN, and h-BN may be present as a result from the synthesis process. As used herein, “boron particle(s)” refers to free boron existing apart from other boron species. The synthesis operating conditions may be adjusted to change the composition of boron particles, relative to the amorphous BN and h-BN species, remaining in the BNNT material. Various purification processes can be used to remove boron particulates, BN, and h-BN, including those disclosed in co-pending International Patent Application No. WO 2018/102423 A1, filed Nov. 29, 2017, which is incorporated by reference in its entirety. It should be appreciated that boron particles may be advantageously retained in some embodiments.

A fusion target based described herein may be irradiated by one or more intense pulsed laser beams. Fusion targets may be formed from various low atomic number elements, such as lithium, beryllium, boron, carbon, nitrogen, fluorine, oxygen, and compounds and nanostructures made therefrom. BNNTs provide several advantages for use as fusion targets, including the ability to control the target structure, and control the density distribution of protons from AB. In some embodiments of the present approach, a hydrogen storage compound, may be used as an additive to the fusion target. The hydrogen storage compound additive enhances the electron density and mass density of the fusion target, and improves the conversion of energy from the laser beam and energetic electrons to photons when the fusion target is irradiated by intense pulsed laser beams.

Under the present approach, the preferred low atomic number elements are boron and nitrogen, and preferably in BNNT nanostructures. It should be appreciated that fusion targets may comprise other low atomic number elements. In general, a low atomic number material as disclosed herein has an average atomic number Z of 10 or lower. For example, the average Z for BN is Z of 6. Pulsed laser beams include beams at optical and near infrared wavelengths of light, beams in the range of ultraviolet (UV) and x-rays, of intensities above 10¹⁶ W/cm² and pulse durations below 500 picoseconds (ps), and for fusion applications, beams with intensities above 10¹⁹ W/cm² and pulse durations below 100 femtoseconds (fs). For the avoidance of doubt, the phrase “intense pulsed laser beam” as used herein generally includes beams having intensities above 10¹⁶ W/cm². When a pulsed laser beam interacts with a fusion target, there are typically compression waves of increased density including increased electron density that propagate into and possibly through the fusion target. There are also reflected electron and mass density waves. Under the influence of an intense pulsed laser beam, the wave of compressed electrons can separate from the wave of compressed and more massive ions that have lost their electrons to the wave of electrons, and thereby create a wakefield type of acceleration electromagnetic field that will accelerate lighter ions, such as protons. The strength and range of the wakefield acceleration depends on multiple parameters, such as the electron density and the intensity of the electromagnetic fields generated by the photon field, which is generated by a combination of the laser and of photons generated by electron interactions with the atoms, ions and other electrons. The resultant plasma may degenerate if the density of electrons is high enough. One benefit of a degenerate plasma in some embodiments is that the process of electrons losing energy from radiation that occur with electron-electron scattering are reduced because the lower energy states of the plasma are not available to the scattered electrons.

For pB11 fusion, protons from below 100 keV to several MeV with the highest cross section near 665 keV will fuse with the ¹¹B in the fusion target to make three alpha (4 He) particles, with typical energies near 2900 keV for 665 keV protons. The alpha particles then collide with surrounding protons and after two or more collisions this results in new protons near the 665 keV region that then continue the pB11 fusion process with surrounding ¹¹B atoms. The combination of the wakefield acceleration of the protons and the pB11 fusion process itself produces the protons with the energies in the region needed for the overall generation of energy from the fusion process.

As mentioned above, a hydrogen storage compound may be used as an additive to the fusion target. In embodiments of the present approach, the preferred hydrogen storage compound is ammonia borane (also referred to as borazane), abbreviated in this disclosure as AB, and having the chemical formula (H₃NBH₃). AB is effective as an additive and hydrogen storage compound in multiple boron nitride (BN) materials, including BNNTs. Further, AB provides a controllable source of hydrogen atoms to provide the protons for pB11 fusion. It should be appreciated that other hydrogen storage compound may be used without departing from the present approach. Examples of other hydrogen storage compound include, but are not limited to, methane, ammonia, alane (Al₃H₉), boron hydrides (such as diborane, B₂H₆), metal hydrides (such as MgH₂, NaAlH₄, LiAlH₄, LiH, LaNi₅H₆, TiFeH₂, palladium hydride), organoboranes, and hydrocarbons.

A combination of multiphoton inverse bremsstrahlung and pondermotive forces along with other laser beam-materials interactions produce the waves of compressed electrons, compressed ions and compressed material including enhanced electron and ion densities including protons for inducing pB11 fusion. These waves are initiated by the photons in the front side of the laser beam pulse, but these waves move at less than the speed of light. Consequently, the photons in the middle and back side of the laser beam pulse catch up to the initial waves and further increase the compressed waves intensities. The fields can become of sufficiently high field strength to produce multi MeV electrons and even multi tens of MeV electrons. In addition, multi hundreds of keV protons and even multi MeV protons are produced when protons are present. There is a positive feedback where these increases in bremsstrahlung photons increases the photon and wakefield type intensities, that in turn increase the number and energies of energetic electrons, that then further increase the bremsstrahlung production with associated further increases in the electron densities, mass densities and wakefield type acceleration of the ions of interest to include protons.

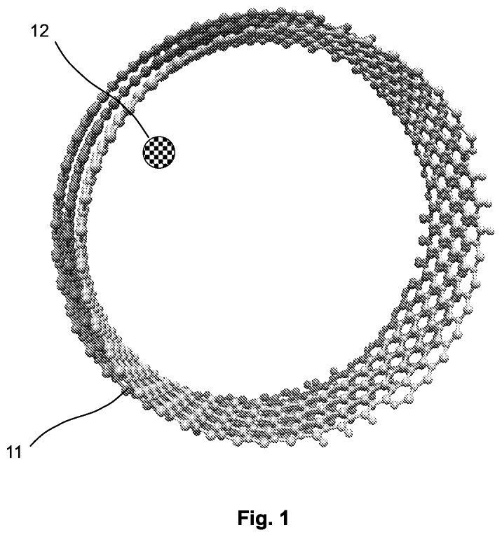

There are a variety of methods for adding a hydrogen storage material into the fusion target. In some embodiments, the hydrogen storage material may be coated onto and fill the fusion target. Gas and liquid based processes are typical. Liquids may involve solvents that are subsequently evaporated. For example, AB may be added to a BNNT fusion target, primarily as a coating. AB's melting point is 97.6° C. or within a few degrees of this value when AB is near other materials, and AB is stable at room temperature. Each molecule of AB contributes six hydrogen atoms, so loading BNNT with AB at preferred concentrations allows for control of the amount of hydrogen available to contribute protons to the fusion target for pB11 fusion processes. An AB molecule is less than roughly 0.3 nm in size, and therefore AB molecules easily fit within the typical BNNT inner diameter of about 1.5 nm-5 nm for the common 2 and 3 wall BNNTs, particularly with high quality BNNTs. FIG. 1 is an illustration comparing the relative sizes of a 4 nm diameter, 3-wall, BNNT 21 with an AB molecule 22. As can be seen, the hydrogen storage compound 22 easily fits within the typical high quality BNNT. AB molecules fit well within the inner diameter of BNNTs. As such, when added using an appropriate process, and AB fit within BNNTs, and also can coat the interior and outer surfaces of the BNNTs. Further, AB will coat BNNT at temperatures near their melting points since both have increasing vapor pressures as they near their melting points. The sequence is to first coat the BNNT surfaces with AB and then cool the reaction vessel to just below the AB melting point. The AB will adequately adsorb both within the BNNT and on the surfaces of the BNNT. The amounts of AB in a given portion of the target can be controlled by the AB deposition processes utilized for some embodiments; multiple processes have been developed and are discussed below. The utilization of BNNT fusion targets filled and coated with AB supports the distribution of hydrogen and ¹¹B atoms within the target material for optimization of the pB11 fusion reactions. In the case of AB, the filling reaction is efficient (e.g., most AB molecules enter the nanotubes) such that the final mass loading of AB in BNNT can be precisely controlled by adding that amount as a reactant (e.g., add 0.8 g of BNNT and 0.2 g of AB for a final mass loading of 20 wt % AB inside of BNNT). The efficiency of the reaction (reactant ratio and final loading) should be determined for each hydrogen storage compound.

In the present approach, one or more hydrogen storage compounds may be added to a BNNT material, through additive processes including, but not limited to, gas-phase filling and solution-phase filling. This description uses AB as a preferred hydrogen storage compound for describing examples, but it should be appreciated that other hydrogen storage compounds may be used. BNNTs may have different Brunauer-Emmett-Teller specific surface areas, ranging from 50-500 m²/g, and the AB will collect on the interior and exterior nanotube surfaces using either gas-phase filling or solution-phase filling.

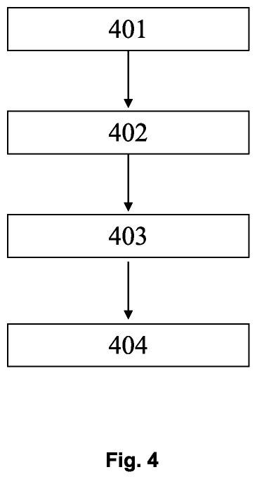

FIG. 4 is a flowchart showing a process for adding a hydrogen storage compound to a BNNT fusion target through a gas-phase additive process, according to one embodiment of the present approach. In step 401, the BNNTs and hydrogen storage compound are added to a reaction vessel at the desired mass ratio. The reactant mass ratio will vary based on the efficiency of the filling process and desired final mass ratio. It is specific to the conditions and hydrogen storage compound (e.g., 0.9 g of BNNT and 0.1 g of AB to achieve 10 wt % loading). The components may be added to the same reaction vessel, or if the hydrogen storage compound is to be forcefully flowed through the BNNT material, then the reaction vessel may include a separate volume to contain the hydrogen storage compound. The BNNT material may be in any formfactor, such as a BNNT powder, a BNNT mat, a BNNT buckypaper, or a BNNT puffball, for example. In some embodiments, the BNNT material may have been processed to open the ends of some or most nanotubes in the BNNT material, thereby allowing the hydrogen storage compound to enter and coat the interior surfaces of the nanotubes (e.g., at a later step). For example, in some embodiments the BNNT material may be heated at about 190° C. to 250° C., for about 12 minutes to about 2 h, and preferably in a vacuum, to remove any residual water or solvents from prior processing. The contents may be added to the reaction vessel at room temperature and pressure, if desired. Depending on the hydrogen storage compound, both the BNNT material and the hydrogen storage compound may be solid at room conditions. In step 402, the hydrogen storage compound is dispersed into the BNNT material. For example, the reaction vessel may be heated to evaporate the hydrogen storage compound. In embodiments with a separate housing for the hydrogen storage compound, the separate housing may be heated to evaporate the hydrogen storage compound, which is then forcefully flowed through the BNNT material. In some embodiments, the reaction vessel may be under a vacuum. In some embodiments, the evaporated hydrogen storage compound may be forced to flow through the BNNT material, such as through a pressurized nozzle or other device known in the art. In some embodiments, the BNNT material may be cooled during the forced flow of hydrogen storage compound, to create a temperature gradient and initiate the localized sublimation. In step 403, the hydrogen storage compound is given sufficient time to thoroughly disperse through and into the BNNT material. The time will necessarily depend on the particular embodiment. In step 404, after sufficient time to allow the hydrogen storage compound to disperse through the BNNT material, the reaction vessel may be cooled to sublime the hydrogen storage compound onto the exterior surfaces and, if open-ended nanotubes are present, the interior surfaces of the BNNT material. It should be appreciated that the process may be repeated to increase the content of the hydrogen storage compound, such as building multiple layers of the hydrogen storage compound.

In a demonstrative example of a gas-phase filling process, the additive process involves placing the BNNT sample and hydrogen storage compound into a reaction vessel. The contents are then placed under vacuum (e.g., about 10⁻³-10⁻² Torr in experimental runs with AB). The contents may then be heated sufficiently to evaporate the hydrogen storage compound (preferably without decomposition), and then the hydrogen storage compound is allowed to intermix with the BNNTs for a desired reaction time before being allowed to sublime on the BNNT interior and exterior surfaces. The extent and efficiency of the gas-phase filling reaction may be controlled by the temperature of the reaction vessel (e.g., heated by an oil bath), the duration of heating, and the properties of the BNNT form factor used. It should be appreciated by the person of ordinary skill in the art that the ideal reaction conditions for a particular embodiment will necessarily depend on the particular embodiment, and that routine experimentation may be used to determine acceptable reaction conditions for a given embodiment. For example, with AB as the hydrogen storage compound, the reaction vessel may be heated to 90-110° C. to sublime the AB for 5 min-12 h. AB is solid and stable in air at room temperature, and AB's melting point is 97.6° C., though the melting point may vary a few degrees depending on the presence of other materials in the reaction vessel. Temperatures above 110° C. may cause AB to decompose into H₂, which would not be preferred for filling a BNNT fusion target. It should be appreciated that the actual gas-phase filling temperature can depend on the environment, including the other molecules in the system. For gas-phase filling, it should be appreciated that any hydrogen storage compound that sublimes at temperatures at which BNNT is stable may be used.

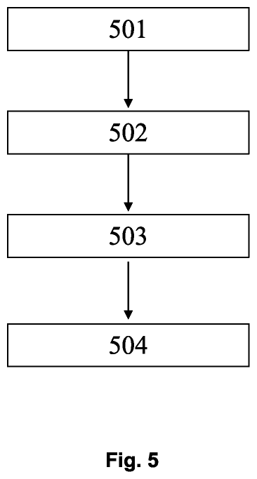

FIG. 5 is a flowchart showing a process for adding a hydrogen storage compound to a BNNT fusion target through a solution-phase additive process, according to one embodiment of the present approach. In step 501, the BNNTs and hydrogen storage compound are put into solution. The components may be in the same solution, or first dissolved in separate, compatible solvents. The BNNT material may be in any formfactor, such as a BNNT powder, a BNNT mat, a BNNT buckypaper, or a BNNT puffball, for example, prior to dissolution. In some embodiments, the BNNT material may have been processed to open the ends of some or most nanotubes in the BNNT material, thereby allowing the hydrogen storage compound to enter and coat the interior surfaces of the nanotubes (e.g., at a later step). In step 502, the hydrogen storage compound is dispersed into the BNNT material. For example, if the components are in separate solutions, then the separate solutions may be mixed. Alternatively, if the components are in the same solution, then the solution may be mechanically mixed using conventional mixing processes, such as sonication, agitation, and the like. In step 503, the hydrogen storage compound is given sufficient time to thoroughly disperse through and into the BNNT material. The time will necessarily depend on the particular embodiment. In step 504, after sufficient time to allow the hydrogen storage compound to disperse through the BNNT material, the solvent(s) are removed through one or more means known in the art, which may include evaporation, drying, filtration, and the like. It should be appreciated that the process may be repeated to increase the content of the hydrogen storage compound, such as building multiple layers of the hydrogen storage compound.

In a demonstrative example of a solution-phase filling, the additive process involves placing the BNNT sample and hydrogen storage compound into solution. Depending on the solubility of the hydrogen storage compound, the components may be placed in the same solvent, or separate compatible solvents and then the separate solutions mixed. In some embodiments, the BNNT and hydrogen storage compound solution may be mixed, such as through sonication or other common methods of mixing solutions to improve filling the BNNT with the hydrogen storage compound. In some embodiments, the solution may be heated to improve filling the BNNT with the hydrogen storage compound. For example, using AB as the hydrogen storage compound, the AB may be dissolved in a solvent suitable for the AB, such as, e.g., water diethyl ether, tetrahydrofuran. Then the BNNT may either be directly added to the AB solution, or the BNNT may be separately added to the same or compatible solvent and then added to the AB solution. The contents are then allowed to interact in solution. In some embodiments, the AB and BNNT solution may be mixed or sonicated by typical lab methods, for anywhere from 5 min to 12 h or more, depending on the particular embodiment and process conditions. It should be appreciated that the person having ordinary skill in the art can determine the appropriate process conditions for a specific embodiment, using routine experimentation. In some embodiments the AB and BNNT solution may not be mixed. In some embodiments the solution of AB and BNNT may be heated to facilitate or accelerate the filling to a temperature up to the boiling point of the solvent or solvent system used. A minimum amount of solvent may be added to minimize the filling of the BNNTs with solvent. It should be appreciated that the reaction conditions, including solvents, concentrations, times, temperatures, reaction vessels, etc., may vary based on both the form factor of BNNTs and the identity of the filling molecule. For solution-based filling, any suitable material which dissolves in solvents compatible with BNNT may be used.

In both gas-phase filling and solution-phase filling, the BNNTs may be in different form factor, including, e.g., powder, puffball, mats, buckypapers, or other form factors. For example, BNNT materials as puffballs from the HTP synthesis process, may be refined to remove boron particulates and/or BN particles. BNNT material as a powder produced by, e.g., freeze drying or lyophilization processes, may be used. BNNT buckypapers, produced by filtration of the BNNT material out of solvents may be used. BNNT fibers produced by spinning processes, and other formfactors may be utilized. The BNNT material or the fusion target may be mechanically pressed either before and/or after the AB filling to achieve the desired density. Some embodiments have preferred target densities for optimizing the electron, proton, and ¹¹B densities for the laser interactions. If the ends of the BNNTs are open, then the AB may enter and fill or coat the interior of the BNNTs. The solvent may enter the BNNTs, which may be preferred in some embodiments to further encourage the hydrogen storage compound to enter into and coat the nanotube surfaces. In some embodiments, more than one type of filling molecule may be used in the reaction vessel at a time. In some embodiments, successive filling cycles may be used to fill and coat the nanotubes with more than one type of molecule. In some embodiments, the nanotube ends may be filled with another molecule to seal the ends and prevent less thermally stable molecules from escaping by a similar process to the hydrogen storage compound filling. For example, the second molecule may have a lower melting temperature and the AB may already have filled the insides and provided a first coating on the outsides of the BNNTs. The second molecule will then provide an additional coating the outside of the BNNTs including the ends, which may be preferred in some embodiments. Further, the distribution of AB within the target does not have to be uniform. For example, the laser target interaction near the surface may primarily be used to create a wave of electrons that then accelerate protons deeper within the target. The efficiency of the loading may be controlled by means of a temperature gradient across the BNNT material. For example, a long BNNT mat may be heated such that it has a temperature gradient in order to create a gradient in the concentration of AB, and thereby control the distribution of protons for the pB11 reaction. After filling with the hydrogen storage compound, the filled and coated BNNT material may be processed to remove material on exterior surfaces of the BNNTs, which may be preferred in some embodiments where having AB inside the BNNTs provides sufficient and preferred protons for the pB11 reaction. For example, the filled and coated BNNTs may be dried, washed, or heated to remove AB from exterior surfaces. The AB inside the BNNTs is somewhat protected from the any solvent being used and heating preferentially removes AB from the outside surfaces when done for short times as determined by observing the AB gas evolve.

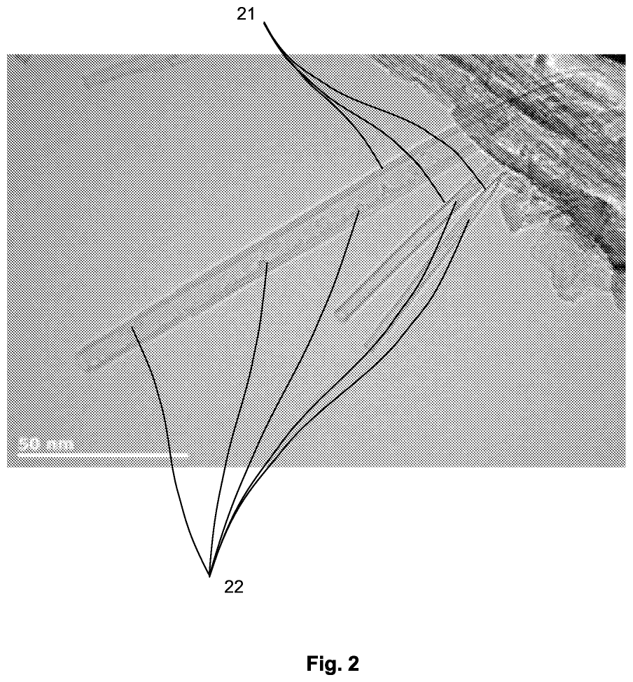

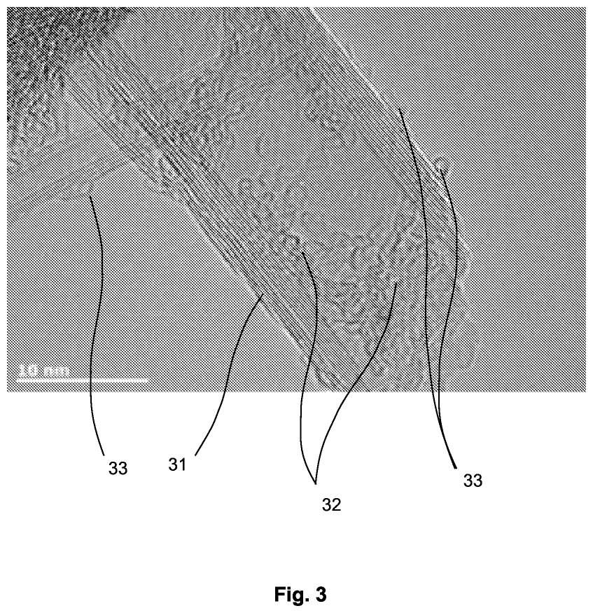

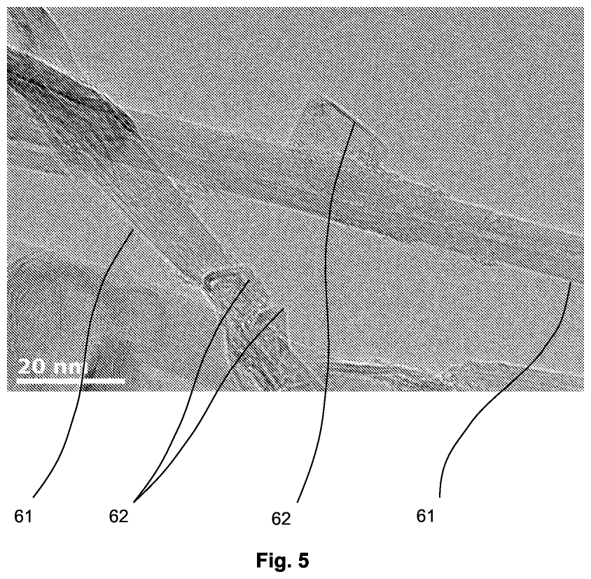

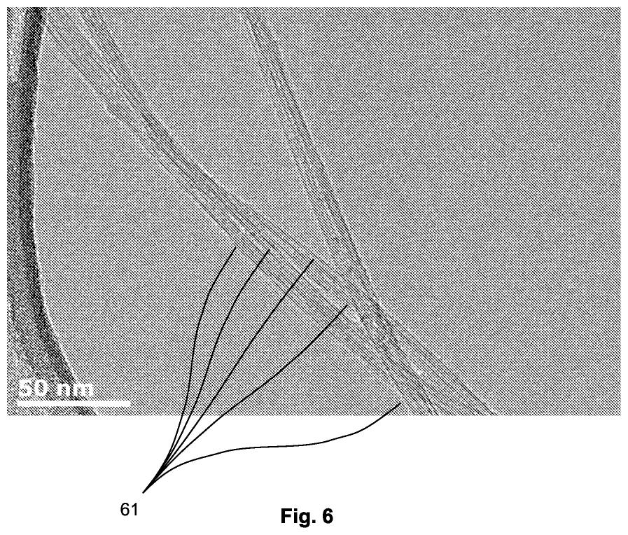

In demonstrative embodiments, the gas-phase loading of AB into BNNT has resulted in AB loadings over 20 wt %, for BNNT in multiple formfactors (e.g., puffballs, mats, buckypapers, and powders). FIGS. 2 and 3 are TEM images of BNNTs filled with AB according to an embodiment of the present approach. As seen in FIG. 2 (which includes a 50 nm scale), AB molecules 22 are present as a coating on the interior surfaces of the BNNTs 21. FIG. 6, provided for comparison shows a TEM image of BNNTs 61, without any hydrogen storage compound or other species, with a 50 nm scale. As seen in FIG. 3 (which includes a 10 nm scale), AB is present as a coating on both the interior 32 and exterior 33 of the BNNT 41 (which is a BNNT with 8-9 walls, while less common in HTP BNNT material, they are present nonetheless). FIG. 7 shows a TEM image of BNNTs 71, without any hydrogen storage compound, with a 10 nm scale for comparison. BN nanosheets nanocages 72 are visible at this resolution. The deposition times and temperatures influence the interior vs. exterior distribution of the AB on the BNNTs.

Intense short pulse laser beams from infrared to x-ray are used at a number of facilities to investigate the properties of matter, create short pulses of intense secondary radiation, such as pulses of protons, and for example at the National Ignition Facility (NIF) to attempt to reach fusion conditions. The specific embodiments of BNNT with AB, described herein are demonstrative of the present approach, and are suitable as targets for pB11 fusion. Hydrogen storage compounds such as AB directly contribute to the fusion process by providing the protons, conveniently arranged in close proximity to boron atoms.

For nanomaterials to include carbon nanotubes (CNTs) and boron nitride nanotubes (BNNT), there have been multiple investigations of getting a variety of atoms and molecules to enter inside the nanotubes. Applications include but are not limited to fusion reactions, understanding the science of one dimensional or other arrays of atoms and molecules that may form within the nanotubes, utilization of the nanotubes to perform drug delivery for medical applications, use nanotubes for storage of hydrogen rich materials such as ammonia borane, and creation of advanced sensor devices that depend on the combination of the CNT or BNNT and the material being held within the nanotubes. Carbon based nano and micro structures to include those with carbon deuterium, CH₂, compounds have been utilized as targets in pulsed laser investigations from producing deuterium based fusion reactions and similar to pB11 fusion discussed above, these CH₂ based targets would benefit from the addition of hydrogen storage compounds. Beyond the fusion reactions discussed above, pulsed lasers being a tool to investigate the structure and dynamics of these materials inside of nanotubes, may benefit from the inclusion of AB or other hydrogen storage compound as part of the pulsed laser target interactions.

The present approach may be embodied in forms other than as disclosed in the various embodiments, as will be appreciated by those having an ordinary level of skill in the art. The present embodiments are therefore to be considered in all respects as illustrative and not restrictive.

The terminology used in the description of embodiments of the present approach is for the purpose of describing particular embodiments only and is not intended to be limiting. As used in the description and the appended claims, the singular forms “a,” “an” and “the” are intended to include the plural forms as well, unless the context clearly indicates otherwise. The present approach encompasses numerous alternatives, modifications, and equivalents as will become apparent from consideration of the following detailed description.

It will be understood that although the terms “first,” “second,” “third,” “a),” “b),” and “c),” etc. may be used herein to describe various elements of the present approach, and the claims should not be limited by these terms. These terms are only used to distinguish one element of the present approach from another. Thus, a first element discussed below could be termed an element aspect, and similarly, a third without departing from the teachings of the present approach. Thus, the terms “first,” “second,” “third,” “a),” “b),” and “c),” etc. are not intended to necessarily convey a sequence or other hierarchy to the associated elements but are used for identification purposes only. The sequence of operations (or steps) is not limited to the order presented in the claims.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the present application and relevant art and should not be interpreted in an idealized or overly formal sense unless expressly so defined herein. All publications, patent applications, patents and other references mentioned herein are incorporated by reference in their entirety. In case of a conflict in terminology, the present specification is controlling.

Also, as used herein, “and/or” refers to and encompasses any and all possible combinations of one or more of the associated listed items, as well as the lack of combinations when interpreted in the alternative (“or”).

Unless the context indicates otherwise, it is specifically intended that the various features of the present approach described herein can be used in any combination. Moreover, the present approach also contemplates that in some embodiments, any feature or combination of features described with respect to demonstrative embodiments can be excluded or omitted.

As used herein, the transitional phrase “consisting essentially of” (and grammatical variants) is to be interpreted as encompassing the recited materials or steps “and those that do not materially affect the basic and novel characteristic(s)” of the claim. Thus, the term “consisting essentially of” as used herein should not be interpreted as equivalent to “comprising.”

Unless otherwise stated, the term “about,” as used herein when referring to a measurable value, such as, for example, an amount or concentration and the like, is meant to encompass variations of ±10%, ±5%, ±1%, ±0.5%, or even ±0.1% of the specified amount. A range provided herein for a measurable value may include any other range and/or individual value therein.

Having thus described certain embodiments of the present approach, it is to be understood that the scope of the appended claims is not to be limited by particular details set forth in the above description as many apparent variations thereof are possible without departing from the spirit or scope thereof as hereinafter claimed.

1. An ¹¹B fusion target comprising:
a boron nitride nanotube (BNNT) material, and
at least one hydrogen storage compound comprising ammonia borane.

2. The ¹¹B fusion target of claim 1, wherein the hydrogen storage compound further comprises a compound selected from the group consisting of methane, ammonia, alane (Al₃H₉), a boron hydride, diborane (B₂H₆), a metal hydride, MgH₂, NaAlH₄, LiAlH₄, LiH, LaNi₅H₆, TiFeH₂, palladium hydride, an organoborane, and a hydrocarbon.

3. The ¹¹B fusion target of claim 1, wherein the hydrogen storage compound consists of ammonia borane.

4. The ¹¹B fusion target of claim 1, wherein the at least one hydrogen storage compound comprises a coating on external surfaces of the BNNT material.

5. The ¹¹B fusion target of claim 4, wherein the at least one hydrogen storage compound further coats interior surfaces of the BNNT material.

6. The ¹¹B fusion target of claim 1, wherein the at least one hydrogen storage compound is dispersed throughout the BNNT material.

7. The ¹¹B fusion target of claim 1, wherein the BNNT material comprises one of a BNNT mat, a BNNT buckypaper, a BNNT powder, and a BNNT puffball.

8. The ¹¹B fusion target of claim 1, wherein the BNNT material comprises a BNNT buckypaper.

9. An ¹¹B fusion target comprising boron nitride nanotubes (BNNTs) with a coating of ammonia borane, the target for use with intense pulsed laser beams for achieving proton ¹¹B fusion.

10. A method for forming an ¹¹B fusion target, the method comprising:
dispersing a hydrogen storage compound comprising ammonia borane into a boron nitride nanotube (BNNT) material in a reaction vessel.

11. The method of claim 10, wherein the reaction vessel is under vacuum.

12. The method of claim 10, wherein the hydrogen storage compound is heated to a temperature sufficient to evaporate the hydrogen storage compound and form an evaporated hydrogen storage compound in the reaction vessel.

13. The method of claim 12, wherein the reaction vessel is cooled to a temperature sufficient to sublimate the evaporated hydrogen storage compound onto surfaces of the BNNT material.

14. The method of claim 10, wherein the hydrogen storage compound further comprises a compound selected from the group consisting of methane, ammonia, alane (Al₃H₉), a boron hydride, diborane (B₂H₆), a metal hydride, MgH₂, NaAlH₄, LiAlH₄, LiH, LaNi₅H₆, TiFeH₂, palladium hydride, an organoborane, and a hydrocarbon.

15. The method of claim 10, wherein the hydrogen storage compound and the BNNT material are in solution comprising at least one solvent.

16. The method of claim 15, wherein dispersing the hydrogen storage compound and the BNNT material comprises mixing the solution.

17. The method of claim 15, wherein the solution is heated to dissolve the at least one solvent.

18. The method of claim 15, wherein the hydrogen storage compound further comprises a compound selected from the group consisting of methane, ammonia, alane (Al₃H₉), a boron hydride, diborane (B₂H₆), a metal hydride, MgH₂, NaAlH₄, LiAlH₄, LiH, LaNi₅H₆, TiFeH₂, palladium hydride, an organoborane, and a hydrocarbon.

19. The method of claim 10, wherein the BNNT material comprises a plurality of nanotubes having open ends.

20. The method of claim 19, wherein the hydrogen storage compound coats interior surfaces and exterior surfaces of the plurality of nanotubes having open ends.
